(19) United States
(12) Patent Application Publication
(10) Pub. No.: US 2009/0305009 A1
(43) Pub. Date: Dec. 10, 2009

(54) PRINTED SUBSTRATE, METHOD FOR MANUFACTURING FLOOR PANELS AND METHOD FOR MANUFACTURING PRINTED SUBSTRATES

(76) Inventors: Laurent Meersseman, Kortrijk (BE); Oke Nollet, Aalter (BE)

Correspondence Address: Capitol City TechLaw, PLLC, PO BOX 1210, VIENNA, VA, 22183, US

(21) Appl. No.: 12/481,041

(22) Filed: Jun. 9, 2009

(30) Foreign Application Priority Data
Jun. 10, 2008 (BE) 2008/0318

(51) Int. Cl. B32B 3/02; B32B 37/10

(52) U.S. Cl. 428/195.1; 156/250; 156/277

(57) ABSTRACT

A printed substrate may be used for manufacturing floor panels that have at least a basic panel and provided thereon a top layer with a printed decor. The printed substrate may include a print. The print may include the printed decors of a plurality of the floor panels. The printed decors in the print may be grouped in stripes of similar tint.

### PRIORITY STATEMENT

This US non-provisional application claims priority under 35 USC §119 to Belgian Patent Application No. 2008/0318 filed Jun. 10, 2008, the content of which is incorporated herein in its entirety by reference.

### BACKGROUND

1. Field of the Invention

In general, the invention relates to printed substrates, a method for manufacturing floor panels on the basis of such printed substrates, as well as to a method for manufacturing such printed substrates.

More particularly, the invention relates to a printed substrate for manufacturing floor panels of the type having at least a basic panel and a top layer with a printed decor provided on the basic panel. The print of the printed substrate includes the printed decors of a plurality of floor panels.

For example, the printed substrates may be applied for manufacturing floor panels substantially consisting of a MDF or HDF (Medium or High Density Fiberboard) basic panel and a top layer provided thereon, such as a laminate top layer.

2. Description of Related Art

Printed substrates and floor panels are well known. According to conventional wisdom, the print of the printed substrate may be printed, whether or not by the intermediary of primer layers, directly on the basic panel, wherein the basic panel then forms the substrate. Alternatively, the print may be provided on a flexible material sheet, such as a paper sheet, wherein this printed material sheet then forms the printed substrate and as such, as a so-called decor layer, is incorporated in the top layer of the floor panel. Further, it is known that the floor panel can be provided with a transparent or translucent synthetic material layer, which forms a protective layer above the printed decor and may comprise, for example, wear-resistant particles, such as aluminum oxide. It is not excluded that this protective layer also includes a material sheet, such as a paper sheet.

In the case of a laminate floor panel, manufacture may take place, for example, according to a DPL (Direct Pressure Laminate) or HPL (High Pressure Laminate) technique. In the case of a DPL technique, one or more material sheets provided with resin, amongst which is a printed material sheet forming a decor layer, are positioned, together with the basic panel or with a larger basic board, in a press device. And by means of a press element and under the influence of increased pressure and temperature, the material sheets are connected to each other as well as to the basic board. In the case of an HPL technique, the top layer is formed separately on the basis of two or more material sheets provided with resin, amongst which is a printed material sheet forming a decor layer. Subsequently, the top layer is provided on the basic board, for example, by being glued on the basic board.

When printing printed substrates, more particularly, when printing decor papers for laminate floor panels, it is known to work with so-called “plank effects”, wherein the print shows areas of different tint, wherein these areas each time correspond to the printed decor of a floor panel. Applying areas of different tint in the print leads to a high color-richness in a floor covering composed on the basis of floor panels with such printed decors of different tint. However, the known application of plank effects requires a relatively accurate division of the printed substrate in said areas and requires a different printed substrate for each format of floor panel, as the size of said areas has to correspond to the format of the floor panels.

Further, it is known to apply a continuous gradual tint modification in the print of printed substrates over the entire width of the substrate, which results in a rather limited increase of the color-richness in a floor covering composed on the basis of floor panels with such printed decors, wherein, however, an accurate division of the printed substrate is not required. A disadvantage of such printed substrates, however, is that in the printed decor of each floor panel a continuous gradual tint modification is present, which can result in an unnatural appearance.

### SUMMARY

The present invention aims at an alternative printed substrate for manufacturing floor panels, wherein, according to various example embodiments, a solution can be offered to one or more of the disadvantages or problems described above. To this aim, the example embodiments relate to a printed substrate for manufacturing floor panels having at least a basic panel and provided thereon a top layer with a printed decor. The print of the printed substrate has the printed decors of a plurality of floor panels, and the printed decors in the print of the printed substrate are grouped in stripes of equal or similar tint.

Due to the fact that the printed decors are grouped according to their tint, a smoother division of the printed substrate in the separate printed decors becomes possible, whereas still a full-value plank effect is maintained. Preferably, the printed decors of two or more floor panels are obtained from a single stripe, wherein dividing the print into these two or more printed decors then can be performed in a less accurate manner. Moreover, the stripe can be divided at choice into several formats of printed decors, such that it will also be profitable in the logistic range in respect to the amount of printed substrates that must be kept in stock. The respective printed decors may be obtained from portions of the stripe concerned located next to each other as well as located after one another. Such arrangement in groups for performing the print also allows a simpler printing process. The aforementioned tint can be obtained, for example, by means of a fond print performed in stripes on the respective substrate, over which a motif print is applied.

Applying a “fond print” or a “fond” means applying a substantially uniform color determining the final appearance of the printed decor. This may relate to a color layer situated beneath the motif print and exerting an influence on the color of the motif print, or to a color layer representing the basic color of the decor concerned. As aforementioned, the fond can be realized by means of a print. Other techniques, such as applying a motif print on a colorized material sheet, which then forms the fond, are not excluded.

It is noted that group-wise arranging printed decors in stripes of equal or similar tint does not exclude that several stripes of the same tint are formed. Preferably, however, all printed decors of equal or similar tint are situated in the same stripe on the printed substrate.

Preferably, the stripes extend with their longitudinal direction in the longitudinal direction of the substrate. In this manner, it is obtained that printed decors for floor panels of different length can be obtained from the same printed substrate.

The printed substrate preferably is applied for manufacturing oblong rectangular floor panels with a like printed decor, wherein these printed decors preferably extend with their longitudinal direction in the longitudinal direction of the stripes. Preferably, the width of the stripes is such that several of such printed decors extend next to each other in the stripe. Of course, it is not excluded that the printed substrate is applied for manufacturing square floor panels with a like printed decor, wherein these printed decors are situated in longitudinal direction of the stripes preferably at least one after the other.

Preferably, the width of all stripes is equal or approximately equal. According to this embodiment, any number of printed decors can be obtained from each stripe. Preferably, the width of the stripes is approximately equal to an even number of times the final width of a floor panel. It is desirable to deviate from the exact coincidence, as material can be removed from the printed substrate when subdividing the latter and/or when finishing the floor panels concerned. For example, it is possible to provide extra material for providing coupling means at the edges of the floor panel.

In a preferred embodiment, the printed substrate is intended for manufacturing floor panels with a printed decor representing a wood motif. Preferably, the print of the printed substrate in width direction of each stripe shows the motif of only a single wooden panel. This means that the depicted wood nerves, wood pores and/or other wood characteristics extend continuously over the stripe in width direction. A stripe with such a wood motif can be subdivided in width direction at choice. In this manner, the respective printed substrate can be applied for realizing floor panels of a plurality of widths.

Preferably, the print of the stripes is constructed of a uniform or virtually uniform background color or fond print and a motif or motif print preferably repeating itself in length direction. Such a print allows for a simple manufacture of the printed substrate.

It will be appreciated that the printed substrate may implement supports of various possible kinds.

According to a first possibility, the substrate may implement a support in the form of a flexible material sheet, such as a paper sheet, which, for example, forms part of a rolled-up printed material web. The material sheet or material web or a portion thereof can be applied as a decor layer in a laminate floor panel. To this aim, for example, the above-mentioned DPL technique may be implemented. Documents WO 91/06728 and WO 2006/074831 show examples of decor paper sheets known from the state of the art.

According to a second possibility, the substrate may implement a support in the form of a board material, on which the print, whether or not with intermediate layers, is applied directly. This may relate, for example, to printing a wood-based board material, such as MDF or HDF (Medium Density Fiberboard or High Density Fiberboard). Directly printing wood-based board materials is known as such, for example, from EP 1 862 304.

For performing the print, any printing technique can be applied, such as, for example, rotation offset printing, screen printing or a digital printing technique, such as inkjet printing.

Example embodiments also relate to a method for manufacturing floor panels. The method involves dividing the printed substrate, wherein at least one of the stripes is subdivided in width direction.

By virtue of the printed substrates according to example embodiments of the present invention, floor panels of different formats can be obtained from the same stripe by subdividing the printed substrate. In the case of the above-mentioned first possibility for the substrate, the printed flexible material sheet or a portion thereof preferably first is provided on the basic board before this material sheet, together with the basic board, is divided. As a basic board, a wood-based board material, such as MDF or HDF, can be suitably implemented. Applying the material sheet or the respective portion thereof on this basic board preferably is performed by means of a DPL technique.

Example embodiments also relate to a method for manufacturing a printed substrate. The method involves providing a fond print on the substrate according to the stripes. The fond print preferably is a print of uniform or approximately uniform color and can be performed, for example, by means of the technique of rotation offset printing.

Example embodiments also relate to coated panels including a printed substrate or a part of a printed substrate, printed substrates, and floor panels, respectively obtained by exemplary methods disclosed herein.

Although the printed substrates and the methods according to example embodiments of the invention are intended in particular for floor panels, it is within the reach of those skilled in the art to apply the teachings disclosed herein for other panels, too, such as wall panels, ceiling panels and the like. In case the disclosed teachings are applied in respect to floor panels, this preferably relates to floor panels which can be applied for composing a floating floor covering. To this aim, the floor panels, at least at two opposite edges and preferably at all edges, include mechanical coupling means by which two floor panels can cooperate with each other, wherein a locking is created in a vertical direction perpendicular to the plane of the floor covering as well as in a horizontal direction in the plane of the floor covering and perpendicular to the coupled edge. Such mechanical coupling means are known as such, for example, from WO 97/47834.

### BRIEF DESCRIPTION OF THE DRAWINGS

With the intention of showing the characteristics of the invention, hereafter, as an example without any limitative character, several example, non-limiting embodiments are described, with reference to the accompanying drawings, wherein:

FIG. 1 is a plan view of a printed substrate according to an embodiment of the invention;

FIG. 2 is a plan view of a floor panel including a portion of a printed substrate according to an embodiment of the invention;

FIG. 3 is a cross-section taken along the line III-III in FIG. 2;

FIG. 4 schematic view of a method for manufacturing floor panels according to an example embodiment of the invention; and

FIG. 5 is an enlarged view of the area F5 in FIG. 3.

### DETAILED DESCRIPTION OF EXAMPLE, NON-LIMITING EMBODIMENTS

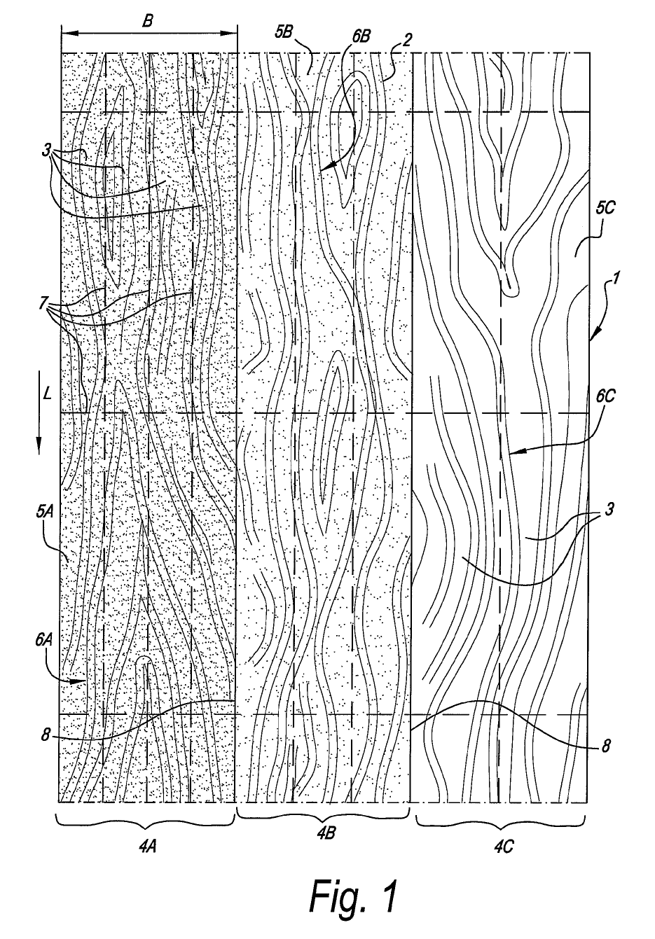

FIG. 1 illustrates a printed substrate 1, which can be applied when manufacturing floor panels. The printed substrate 1 includes a print 2 in which the printed decors 3 of a plurality of floor panels are grouped in stripes 4A-4B-4C of similar or approximately equal tint. In this example, the printed substrate 1 includes three stripes 4A-4B-4C of different tint, all of the stripes having approximately the same width B. The stripes 4A-4B-4C extend with their longitudinal direction in the longitudinal direction L of the substrate 1.

It will be appreciated that the number of stripes in a given substrate is not limited. The width B of each of the stripes 4A-4B-4C approximately corresponds to the width of one or more floor panels, and preferably to the width of at least two floor panels. Of course, material to be removed when dividing the printed substrate 1 and further finishing the floor panels can be taken into account here. Preferably, the printed substrate 1 comprises at least three stripes 4A-4B-4C and a maximum five stripes, wherein all stripes preferably have substantially the same width B or wherein, in other words, they can all be applied for forming an identical number of floor panels.

The printed substrate 1 of FIG. 1 is intended for manufacturing floor panels with a printed decor 3 representing a wood motif. In width direction B of the stripes 4A-4B-4C, the motif represents only a single wooden panel. Thus, in the stripes 4A-4B-4C as such, in this example, there is no so-called plank effect at all. This can be obtained, such as here, by applying no or almost no differences in the fond 5A-5B-5C or basic color of a stripe 4A-4B-4C in function of the final floor panels and by having the wood motif 6A-6B-6C continue uninterruptedly or almost uninterruptedly over the entire stripe 4A-4B-4C, whether or not with repeats, for example, in the longitudinal direction L of the stripe 4A-4B-4C.

FIG. 1 clearly shows that the print 2 of the stripes 4A-4B-4C is composed of a uniform or virtually uniform background color or a fond print 5A-5B-5C and a motif 6A-6B-6C or motif print provided thereover.

The dashed lines 7 show that the printed substrate 1 may be divided into a plurality of printed decors 3. According to the desired format of the final floor panels, each time one or more floor panels can be manufactured on the basis of the width B of the stripes 4A-4B-4C. By way of example only, the stripe 4A on the left hand side of the figure may be divided into 4 adjacent relatively narrow panels; the stripe 4B in the center of the figure may be divided into 3 adjacent panels of relatively medium width; and the stripe 4C on the right hand side of the figure may be divided into two adjacent, relatively wide panels. It will be appreciated that each stripe in the substrate 1 may be divided into a different number of panels (as shown) or the same number of panels.

An interesting possibility is created, for example, when a stripe can be divided at choice into at least 2 floor panels having a width of 14 to 16 cm, or at least 3 floor panels having a width of 9 to 11 cm, or at least 5 floor panels having a width of 6 to 7 cm, almost without waste, however, taking into account the material possibly to be removed. This is possible, for example, when the width of the stripe is situated between 30 and 40 cm or when the width of the stripe approximately corresponds to a multiple of 35 cm.

By way of example only, the length of the printed decors or of the floor panels may vary between 40 and 240 centimeters, wherein a length of 100 to 140 centimeters is preferred. A length of 100 to 140 centimeters approximately corresponds to the circumference of standard printing cylinders which can be applied in rotation offset printing, such that a repetition of the motif over this length is simple to avoid.

Although the transitions 8 among the different stripes 4A-4B-4C are represented clearly in the example, in practice techniques can be applied for blurring them, for example, by having the prints 2 of adjacent stripes at such transition 8 gradually merge into each other.

The substrate 1 can implement a support of the previously mentioned first possibility (i.e., a printed, flexible material sheet) or second possibility (i.e., a printed board material). In the case that a substrate 1 of the first possibility is concerned, namely, a flexible material sheet, this material sheet preferably, either entirely or partially, is applied as a decor paper for manufacturing floor panels by means of a DPL technique.

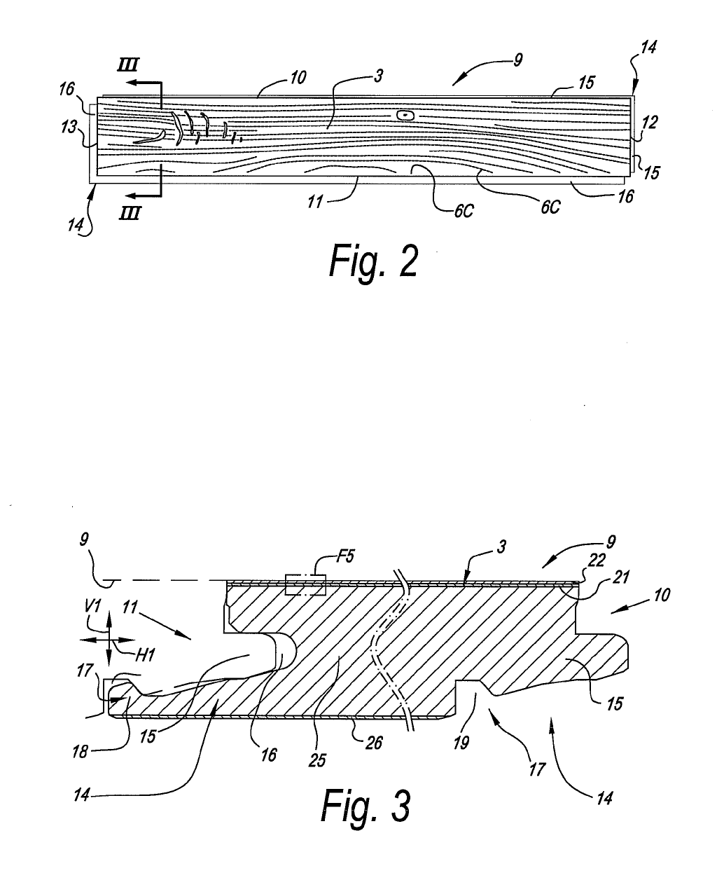

The printed substrate 1 or a portion thereof can be applied, for example, for manufacturing the floor panel 9 of FIG. 2.

The floor panel 9 of FIG. 2 is an oblong, rectangular floor panel 9 intended for forming a so-called floating floor covering, wherein this floor panel 9, at least at two opposite edges 10-11 and here at all opposite edges 12-13, comprises mechanical coupling means 14 that allows two floor panels 9 to be coupled to each other at their edges 10-11-12-13. The invention is not limited to floor panels 9 with a printed decor 3 representing a wood motif 6C. For example, floor panels 9 can be applied as well with printed decors 3 representing another motif, such as a stone motif, a tile motif, a cork motif, a bamboo motif or a fantasy motif.

FIG. 3 illustrates that when coupling the floor panels 9, a locking is created in a vertical direction V1 perpendicular to the plane of the coupled floor panels 9, as well as in a horizontal direction H1 perpendicular to the respective edges 10-11 and in the plane of the coupled floor panels 9. The locking in the vertical direction V1 is obtained in particular in that the mechanical coupling means 14 substantially is performed as a tongue-in-groove connection 15-16. For realizing the locking in the horizontal direction H1, the tongue 15 and groove 16 include locking elements 17 in the form of an upright portion 18 at the underside of the groove 16 and a portion 19 cooperating therewith at the underside of the tongue 15.

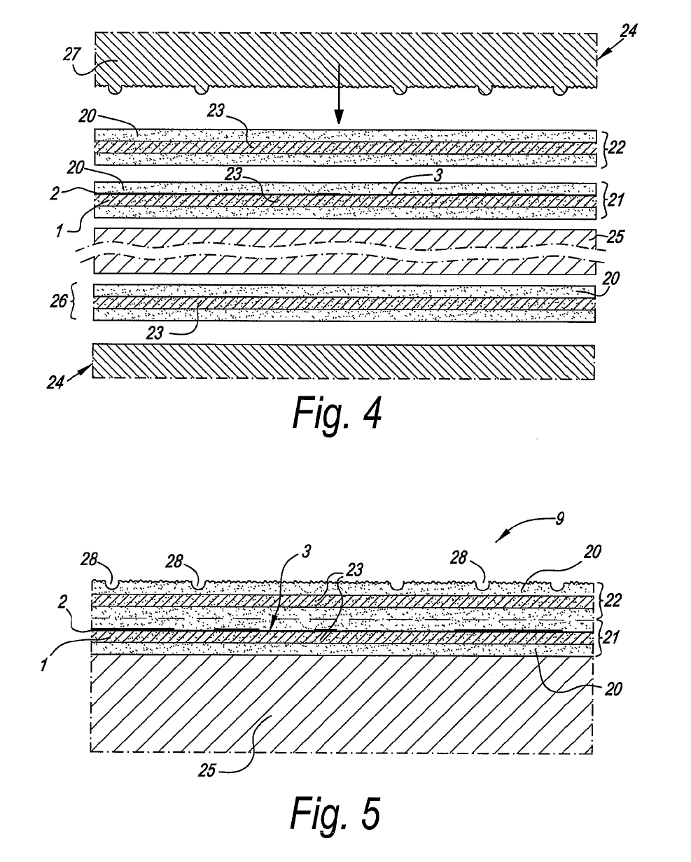

FIG. 4 illustrates a method for manufacturing floor panels 9, such as the floor panel 9 depicted in FIG. 2, by means of a DPL technique. A decor layer 21 provided with resin 20, in this case a portion of the printed substrate 1, and an overlay 22, which also comprises a paper sheet 23 provided with resin 20, are consolidated in a press device 24 with a basic board 25. At the underside of the basic board 25, by means of the same press treatment a backing layer 26 or balancing layer is provided, which also comprises a paper sheet 23 provided with resin 20. The respective decor layer 21 can be obtained from a larger decor paper web, wherein the resin 20 is provided on the printed paper sheet 23 of the decor layer 21 while this paper sheet 23 did or did not still form part of the decor paper web. Thus, the decor layer 21 concerned may comprise the printed decors 3 intended for a plurality of floor panels 9. Therefore, by means of the press treatment preferably larger coated boards are obtained, which, in a further treatment, are divided into panels showing approximately the dimensions of the final floor panels 9. The basic board 25 in such case is suitable for forming the basic boards of a plurality of floor panels 9.

As shown in FIG. 4, the press device 24 comprises a structured press element 27, for example, a press plate. By way of example only, the press element 27 may include features that form impressions 28 (see FIG. 5) in the decorative side of the larger coated panels. Preferably, the impressions 28 realized in this manner correspond at least to a portion of the print 2 of the decor layer 21 or follow at least a portion of this print 2. The structure of the press element 27, and thus the press element itself, is independent from the final format of the floor panels, or, in other words, independent from the number of printed decors into which one and the same web is divided, while still obtaining matching impressions.

FIG. 5 illustrates the obtained floor panel 9 or the larger coated board, from which it becomes clear that the application of a structured press element results in impressions 28 in the decorative side of the floor panel 9. The impressions 28 preferably have a deepest point situated above the print 2 of the decor layer 21.

In the case of the floor panel 9 from FIG. 2, the impressions 28 can form imitations of the structure of wood characteristics, such as wood pores, wood nerves, wood silver grains or wood knots, which then possibly correspond to similar wood characteristics depicted in the printed decor 3 of the floor panels 9.

It is clear that when in the foregoing, a different tint is mentioned, this relates to tints of a same general decor. For example, this may concern floor panels all representing a naturally varnished oak wood plank as a general decor, however, wherein the individual decors of the floor panels have different tints or degrees of darkness. Providing such tint differences, or “plank effects”, provides for higher natural color richness in a floor covering composed on the basis of such floor panels.

For the sake of clarity, it is also noted that a typical width for a printed substrate according to example embodiments of the invention can be situated between 1.5 and 3 meters.

The present invention is in no way limited to the above-described example embodiments; on the contrary, such printed substrates and methods may be realized according to numerous and varied embodiments, without departing from the spirit and scope of the present invention.

What is claimed is:

1. A printed substrate for manufacturing floor panels, each of the floor panels having at least a basic panel and a top layer with a printed decor provided on the basic panel, the printed substrate comprising:
a support; and
a print provided on the support;
wherein the print includes the printed decors of a plurality of floor panels; and
wherein the printed decors in the print are grouped in stripes of similar tint.

2. The printed substrate of claim 1, wherein the stripes extend with their longitudinal direction in a longitudinal direction of the printed substrate.

3. The printed substrate of claim 2, wherein the printed decors represent a wood motif; and wherein the print of each stripe in width direction of the stripe represents the motif of only a single wooden panel.

4. The printed substrate of claim 2, wherein the print of each stripe is constructed of a uniform fond print and a motif print that repeats itself in the longitudinal direction.

5. The printed substrate of claim 1, wherein the support is a flexible material sheet.

6. The printed substrate of claim 1, wherein the support is a board material on which the print is provided directly.

7. A method for manufacturing floor panels using the printed substrate of claim 1, the method comprising:
dividing the printed substrate, such that at least one of the stripes is divided in width direction.

8. The method of claim 7, wherein the floor panels are obtained by a DPL technique.

9. A method for manufacturing the printed substrate of claim 1, the method comprising:
providing a fond print on the substrate in accordance with the stripes.
